(19) United States
(12) Patent Application Publication
(10) Pub. No.: US 2010/0177102 A1
(43) Pub. Date: Jul. 15, 2010

(54) INCREMENTAL POLYGON TRIANGULATION FOR DIGITAL DISPLAY

(76) Inventors: Luc Klaine, Lannion (FR); Anthony Saunier, Lannion (FR)

Correspondence Address: STITES & HARBISON PLLC, 1199 NORTH FAIRFAX STREET, SUITE 900, ALEXANDRIA, VA, 22314, US

(21) Appl. No.: 12/649,530

(22) Filed: Dec. 30, 2009

(30) Foreign Application Priority Data
Dec. 31, 2008 (FR) 08 59169

(51) Int. Cl. G06T 11/20

(52) U.S. Cl. 345/441

(57) ABSTRACT

A conforming triangulation method, for a digital display on a terminal screen, comprising
receiving an identifier of a point to be added to/removed from an ordered list of points corresponding to a polygon, this polygon having been the subject of a previous conforming triangulation,
determining, as a function of the received identifier and a list of conforming triangles obtained by the previous triangulation, an ordered sub-list of points in the ordered list, this sub-list corresponding to a portion of the polygon, and adding/removing the point to be added to/removed from the sub-list,
carrying out a conforming triangulation of the polygon corresponding to the sub-list, and
updating the list of conforming triangles obtained by the previous triangulation, as a function of the results of the triangulation, for a display on the screen.

The present invention relates to the field of conforming triangulation of a polygon, for a digital display on a terminal screen.

The invention is more particularly suited to on-board applications, for example digital mapping, on mobile terminals, for example mobile phones, personal digital assistants or PDAs, etc. Such applications are for example implemented in mobile terminals that are capable of communicating with a server.

It is known to carry out a triangulation of any polygon in order to obtain conforming, i.e. non-overlapping triangles. Thus, a polygon with N ordered points can be triangulated into (N-2) conforming triangles, without intersection of the edges except at the vertices of the polygon.

Such conforming triangles are relatively easy to display, for example using a graphics card. This relatively easy display can be particularly useful in the case of terminals with relatively little storage and/or calculation capacity, of the mobile phone type.

However, it is possible for points to be added to or removed from a polygon when this polygon is already triangulated, and optionally displayed. For example, the points corresponding to a certain level of detail can be transmitted from a server to the terminal only if the user of the terminal wishes, for example for zooming in.

With the known conforming triangulation methods, it is necessary to add the points concerned to or remove them from an ordered list of points corresponding to the already triangulated polygon, then carry out a new triangulation starting from all of the points in this list of points updated in this way.

Thus, for one point added to a polygon with approximately one thousand points, it is necessary to carry out a new triangulation on approximately one thousand points.

The purpose of the invention is to make it possible to update the triangulation and the display of a previously triangulated polygon more quickly.

According to a first aspect, the invention aims a conforming triangulation method for a digital display on a terminal screen, comprising

a/receiving an identifier of a point to be added to/removed from an ordered list of points corresponding to a polygon that has already been the subject of a previous conforming triangulation,

b/determining, as a function of the received identifier and a list of conforming triangles obtained by the previous triangulation, an ordered sub-list of points in the ordered list, this sub-list corresponding to a portion of the polygon,

c/adding/removing the point to be added to/removed from the sub-list,

d/carrying out a conforming triangulation of the polygon corresponding to the sub-list obtained in stage c/, and

e/updating the list of conforming triangles obtained by the previous triangulation, as a function of the results of the triangulation in stage d/, for the display on the screen of the triangles in the updated list.

Thus, rather than carrying out a new triangulation of the whole of the polygon, a portion of polygon affected by the point addition/removal is determined and the triangulation is carried out on this portion of the polygon only, taking into account the point to be added or removed. The triangulation of the remainder of the polygon can thus be retained. Such an incremental/decremental triangulation method can make it possible to avoid tedious calculations, in particular when the number of points of the polygon is high.

The ordered sub-list can comprise two points or more. For example when the given point is to be added to the polygon and this given point does not belong to any of the triangles of the previous triangulation (point external to the polygon), the ordered sub-list comprises only two points in the ordered list. The sub-list then corresponds to one side of the previously triangulated polygon. In stage c/, the given point is added to this sub-list, and the triangulation in stage d/leads to a single triangle having the three points in the sub-list as vertices.

For example, when the given point is to be removed from the list, and the triangle formed by this given point and the points preceding and following this given point in the ordered list is one of the conforming triangles obtained by the previous triangulation, the ordered sub-list comprises only these three points. The sub-list then corresponds to one of the triangles of the previously triangulated polygon. In stage c/, the given point is removed from the sub-list, and the triangulation in stage d/is trivial.

The method described above is applicable to an uncrossed polygon, which is not prejudicial to the extent that a crossed polygon can be broken down into several uncrossed polygons.

This method can be used in the context of a multi-resolution approach. A server can for example store the points of a polygon in a memory structured by levels of detail: the points corresponding to a high level of detail are stored together, while those corresponding to a lower level of detail are stored elsewhere.

The classification of the points by level of detail can be carried out using for example the method described in application WO2008003687. For example, for each point of the polygon, an area is calculated between this point, the previous point and the following point in the ordered list corresponding to the polygon. The value of this area provides an indication of the level of detail of this point.

When a user wishes to display on his terminal an object corresponding to a polygon with a given level of detail, the server sends the terminal an ordered list of points with only the points corresponding to this level of detail and to the lower levels of detail. A triangulation is carried out and the conforming triangles obtained are displayed on the screen.

If the user wishes to display this object with more details, for example when zooming in, the server sends the terminal coordinates of the points corresponding to the desired level of detail, as well as indications of the order of these points within the ordered list previously transmitted. The incremental triangulation method described above can then be implemented for each point added, in order to avoid complete re-triangulation of the polygon.

If the user wishes to display this object with fewer details, for example when zooming out, the server sends the terminal the identifiers of the points in the previously transmitted list that would correspond to points to be removed. The decremental triangulation method described above can then be implemented for each point removed, in order to avoid a complete re-triangulation of the polygon.

Generally, two embodiments are envisaged, the first consisting of adding a point to the already triangulated polygon (incremental triangulation), the second of removing a point from the already triangulated polygon (decremental triangulation).

In the first embodiment, the identifier of the received point comprises coordinates of this point and an indication of the order of said point. The method comprises:
adding this received point to the ordered list of points corresponding to the previously triangulated polygon, in an array given by the order indication received,
in stage b/, determining whether the received point is located outside the previously triangulated polygon,

if appropriate, in stage e/, adding to the list of triangles corresponding to the previous triangulation the triangle formed by the received point and the two points in the ordered list adjacent to said received point,

otherwise determining during stage b/a set of at least one triangle in the list of triangles corresponding to the previous triangulation, this set being constituted by all the triangles in this list at least partly covered by the triangle formed by the received point and the two points in the ordered list adjacent to said received point, and choosing as points in the ordered sub-list the points corresponding to this set.

It is thus possible to determine the portion of the polygon to be re-triangulated in the event of the addition of a point.

In order to determine whether the received point is situated outside the previously triangulated polygon, it is envisaged to use an indication received with the coordinates of this point. For example, a variable on a bit is received with the coordinates of a point to be added, the value of the variable indicating whether this point is outside the polygon corresponding to the levels of detail lower than the level of detail of the received point.

Alternatively, no indication is sent and it is determined whether the received point is situated outside the polygon in another way. For example the following are determined:
the sign of the area of the triangle formed by the point preceding the received point in the ordered list of points, the received point and the point following the received point in this list,
the sign of the area of the triangle in the list of conforming triangles comprising these preceding and following points.

If these signs are different, it is then considered that the received point is situated outside the polygon. This method requires relatively little calculation time.

The invention is also not limited by the way in which the set of triangles can be determined when the received point is situated inside the previously triangulated polygon. For example, if the received point is in the triangle in the list of triangles comprising the two points in the ordered list adjacent to the received point, the vertices of this triangle are chosen as points in the sub-list of points. Otherwise, the vertices of the triangle are selected from the list of triangles comprising said two points in the ordered list as points in the sub-list, then for a current triangle initially being this triangle in the list of triangles that comprise these two points in the ordered list, the following stages are carried out:

b1/choosing a triangle adjacent to the current triangle sharing with this current triangle an edge visible from the received point,

b2/selecting the vertices of the adjacent triangle as points in the sub-list,

b3/if the received point is outside the adjacent triangle, repeating stages b1/, b21 and b3/considering the adjacent triangle as the current triangle, until the adjacent triangle to which the received point belongs is found.

In stage b1/, the choice of the triangle adjacent to the current triangle sharing with it an edge visible from the received point, can for example be based on comparisons of signs of areas of signed triangles, which allows for this choice to be made relatively rapidly, in a way requiring little calculation time.

The invention is not limited by the way in which the points in the ordered sub-list of points are selected. For example, in stage b2/, it is possible to write to the memory identifiers of the vertices of the adjacent triangles, and all of the vertices obtained when the adjacent triangle to which the received point belongs is found, constitute, after an optional re-ordering, the ordered sub-list of points. Alternatively, in stage b2/, it may be enough to write to the memory the identifier of the adjacent triangle; then, when the adjacent triangle to which the received point belongs is found, the points in the sub-list of points are easily determined on the basis of all of the triangles thus obtained.

In a second embodiment, an identifier of a point in the ordered list of points corresponding to the previously triangulated polygon is received, i.e. an identifier of a point to be removed.

Advantageously, in the event of the removal of a point, the ordered sub-list of points is constituted by all the points of the triangles having the point to be removed as a vertex.

For example, if the point to be removed is associated with a single triangle, in stage e/, this triangle is removed from the list of triangles. The removed point is as it were outside the updated polygon.

If the point to be removed is associated with several triangles, in stage b/, a set of at least one triangle of the previous triangulation is determined, this set being constituted by all the triangles having the received point as a vertex, and the points corresponding to this set are chosen as points in the ordered sub-list.

Also, the ordered list of points is updated by removing the received point from this ordered list of points.

The points can have two-dimensional or three-dimensional coordinates. In the case of three-dimensional coordinates, the method is applied in the plane of the polygon to be re-triangulated.

Advantageously and non-limitatively, it is possible to make provision to retain for each edge of the previously triangulated polygon an identifier of the triangle (among the triangles in the list of conforming triangles obtained by the previous triangulation) that comprises this edge. Such a list of triangles of edges can make it possible to determine the ordered sub-list of points more rapidly.

In fact, in the event of the addition of a point, it is easy to find, from a received point and the ordered list of points, the edge corresponding to the points preceding and following the received point in the ordered list. The list of triangles of edges then makes it easy to find the triangle corresponding to this edge, thus avoiding examining each triangle in the list of conforming triangles.

In the event of the removal of a point, it is easy to find, from a received point and the ordered list of points, the two edges corresponding to the points preceding and following the received point in the ordered list. The list of triangles of edges then makes it easy to find the triangle or triangles corresponding to these edges, thus avoiding examining each triangle in the list of conforming triangles.

Advantageously, provision can be made to retain for each triangle in the list of triangles the identifiers of any adjacent triangles.

In the event of the addition of a point, this can make it possible to facilitate the determination of the set of triangles at least partly covered by the triangle formed by the received point and the two points in the ordered list adjacent to this received point. Alternatively, it is of course possible to examine all of the triangles in the list of triangles and to determine for each of these triangles whether this triangle is adjacent to a current triangle.

In the event of the removal of a point, this can make it possible to easily select the adjacent triangles comprising the point to be removed, without having to examine the list of triangles in order to find the triangles comprising shared edges.

According to another aspect, the invention aims a triangulation device for a digital display on a terminal screen, this device comprising
a memory unit for storing an ordered list of points corresponding to a polygon, as well as a list of conforming triangles obtained by conforming triangulation on the basis of this ordered list of points,
means of receiving an identifier of a point to be added to/removed from the ordered list of points,
first processing means for determining, as a function of the received identifier and the list of conforming triangles, an ordered sub-list of points in the ordered list, this sub-list corresponding to a portion of the polygon,
second processing means for adding/removing the point to be added to/removed from said sub-list,
triangulation means connected to an output from the second processing means, for carrying out a conforming triangulation of the polygon corresponding to said sub-list, and
updating means arranged for updating, as a function of the conforming triangles obtained by the triangulation means, the list of conforming triangles stored in the memory unit, for the display of the triangles in said updated list on the screen.

This device can make it possible to implement the method described above. According to yet another aspect, the invention aims a triangulation computer program product for the display of obtained triangles on a terminal screen, the computer program being intended to be stored in a memory of a terminal, and/or stored on a storage medium intended to cooperate with a reader of this terminal and/or downloaded via a telecommunications network, characterized in that it comprises instructions for executing the stages of the method described above.

Other characteristics and advantages of the invention will also become apparent on reading the following description. The description is purely illustrative and must be read in light of the attached drawings, in which:

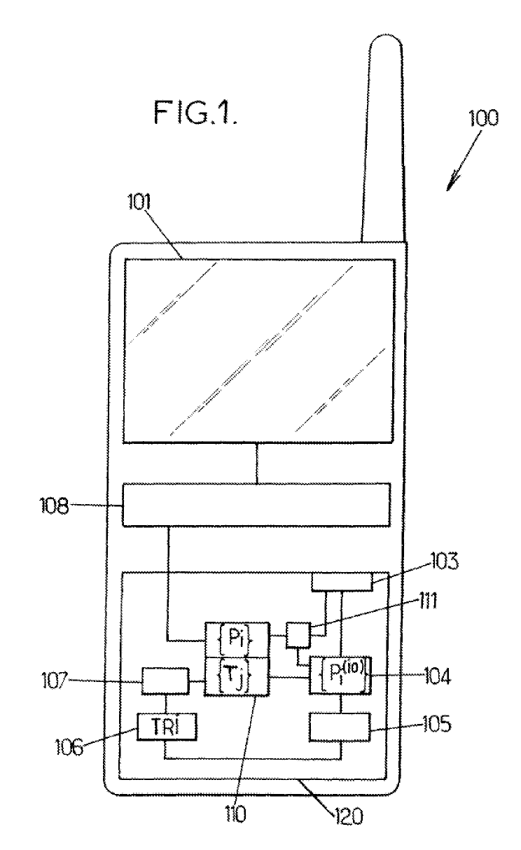

FIG. 1 shows an example of a device according to an embodiment of the invention.

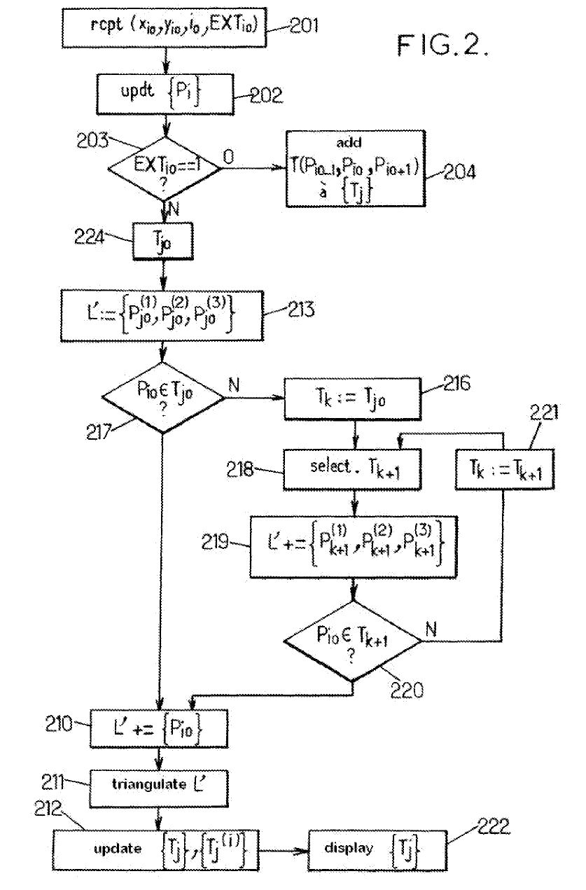

FIG. 2 is an example of a flow chart of a method according to an embodiment of the invention;

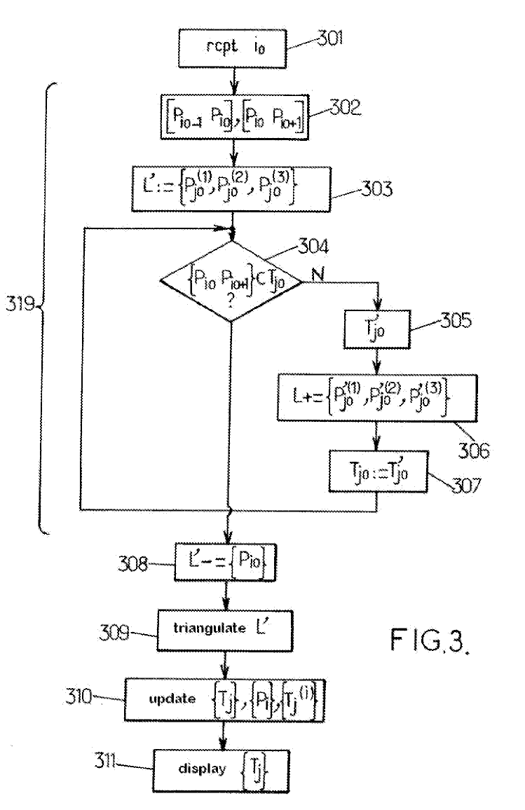

FIG. 3 is an example of a flow chart of a method according to an embodiment of the invention;

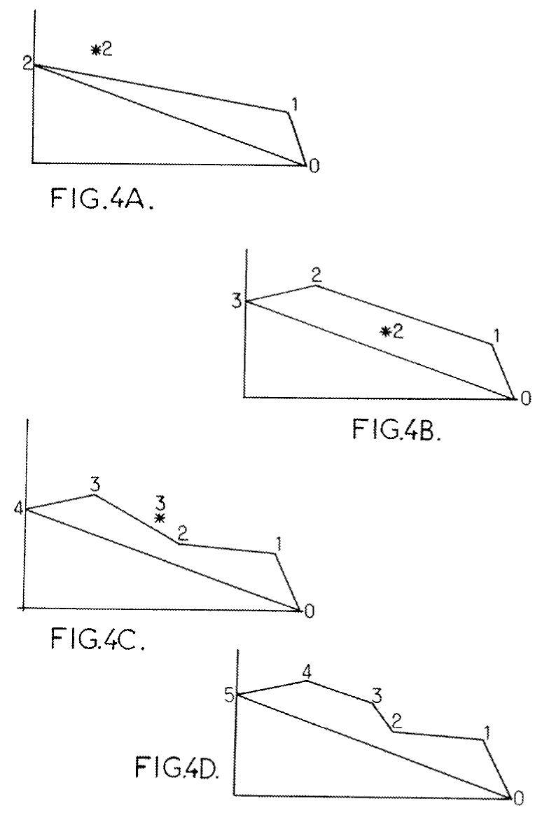

FIGS. 4A to 4D show examples of additions of points to a polygon;

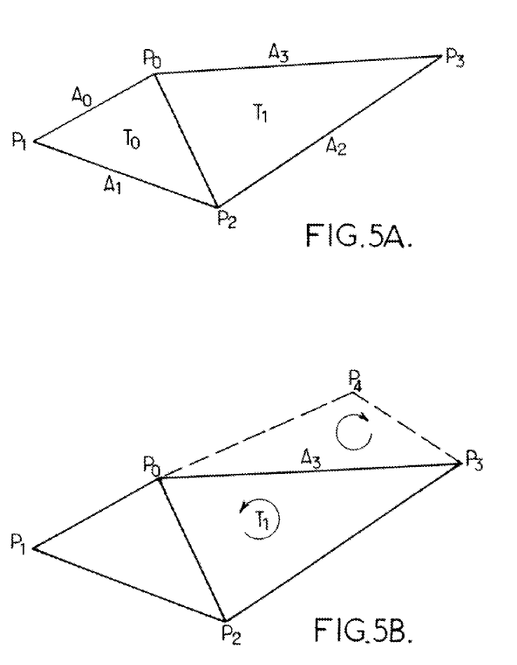

FIGS. 5A and 5B show an example of the addition of a point outside the previously triangulated polygon;

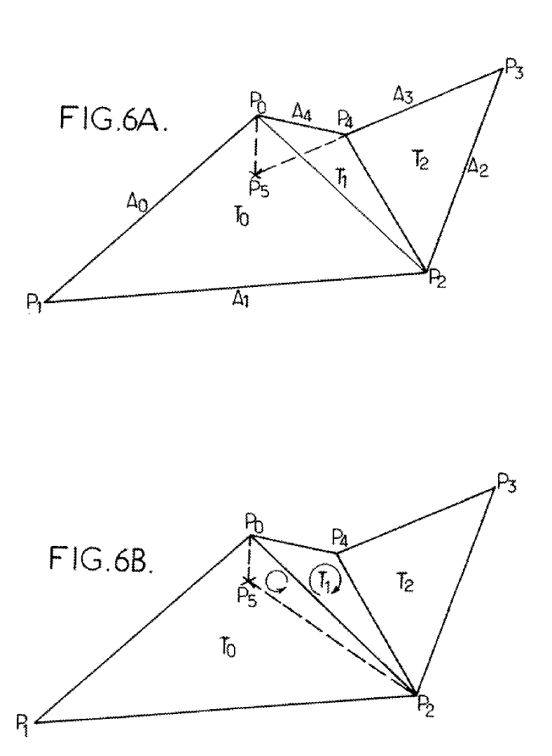

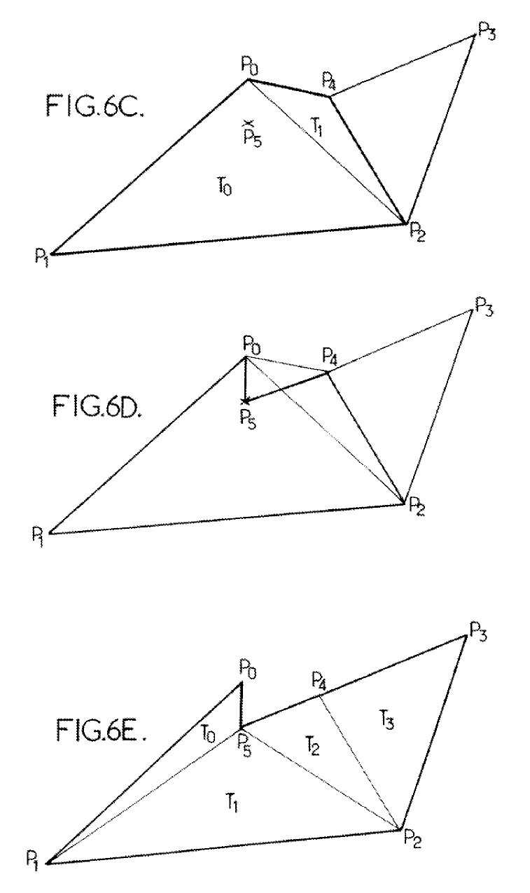

FIGS. 6A to 6E show an example of the addition of a point inside the previously triangulated polygon.

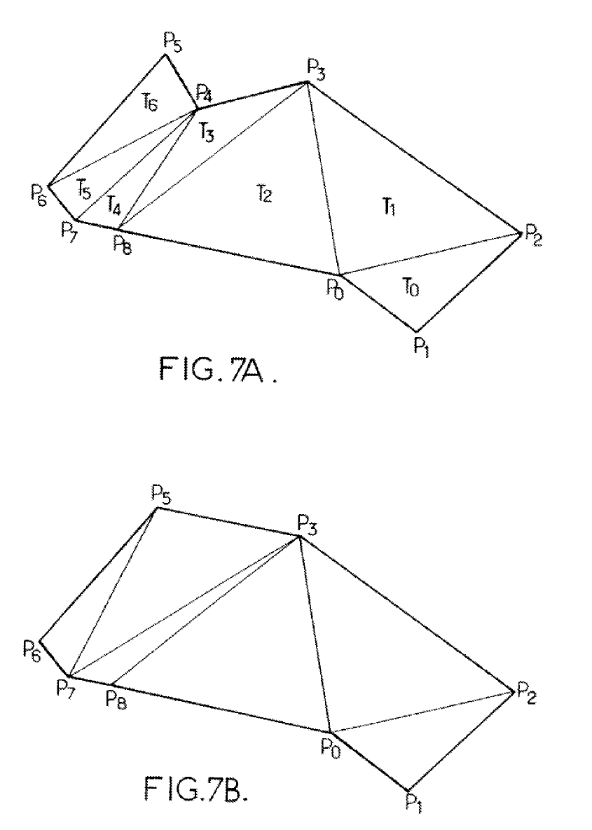

FIGS. 7A to 7B show an example of removal of a point from a previously triangulated polygon.

With reference to FIG. 1, a terminal 100, for example a mobile phone, a PDA (“Personal Digital Assistant”), a laptop, or other device, comprises a screen 101, an antenna, and a triangulation device, for example a processor 120.

The processor 120 comprises receiving means 103, for example an input port, a pin, a bus, or other means, for receiving an identifier of a point to be added or removed from an ordered list of points stored in a memory unit 110. This identifier can be received from an external server, not shown, via the antenna, or also from a memory inside the terminal, not shown.

This identifier can for example comprise spatial coordinates of a point and an identifier of the order of this point in the ordered list of points, for example a value of an index array or a pointer.

Updating means 111, for example a processor or part of a processor, make it possible to add this received point to the list of points stored in the memory unit 110, in an array given by the received array index value.

Provision can be made for some of the points initially present in the list, for example the points initially having an index greater than the received index, to have their array index modified during this updating. Alternatively, the index associated with each point has a fixed value, calculated taking into account a maximum number of points (corresponding for example to a maximum level of detail).

The memory unit 110 can comprise one or more read- and write-accessible memories. This memory unit makes it possible to store, in addition to the ordered list of points, a list of conforming triangles obtained by a previous triangulation of this ordered list of points. The memory unit can be arranged so as to store for each triangle in the list of triangles the identifiers of the vertices of this triangle and the identifiers of any adjacent triangles. The memory unit can make it possible to also store a list of triangles of edges, not shown, comprising for each edge of the polygon an identifier of the triangle to which this edge belongs.

First processing means 104, for example a processor or part of a processor, make it possible to determine, as a function of the received identifier and the list of conforming triangles, an ordered sub-list of points in the ordered list. These processing means are arranged in order to carry out the stages described with reference to FIG. 2, which is explained below.

The ordered sub-list corresponds to a portion of the polygon corresponding to the initial list of points. Within the ordered sub-list, the points are ordered according to the value of the array index used in the list stored in the memory unit.

Second processing means 105, for example a processor or part of a processor, make it possible to add the received point to the points in the sub-list, in the appropriate array.

This ordered sub-list thus defines a polygon, which is smaller than the polygon corresponding to the triangles in the list of triangles stored in the memory unit 110. The polygon corresponding to the sub-list is the subject of a triangulation, independently of the other points in the ordered list of points stored in the memory unit 110. Triangulation means 106, for example a processor or part of a processor, are provided for this purpose.

These means 106 make it possible to obtain an output of one or more triangles. Updating means 107, for example a processor or part of a processor, are provided in order to update, as a function of the conforming triangle or triangles obtained by the triangulation means 106, the list of conforming triangles stored in the memory unit 110.

This list stored in the memory unit 110 is read by means 108, for example a graphics card or a processor dedicated to the display of triangular areas. These means 108 make it possible to display the triangles in the list of triangles on the screen 101.

The identifier received by the receiving means 103 can comprise an identifier of a point in the ordered list of points stored in the memory unit 110. This identifier can for example comprise an indication of the fact that the received point belongs to the stored list and an array index of this point in this list.

In this case, the first processing means 104 determine the triangle or triangles in the list of triangles stored in the memory unit, which have the received point as a vertex. All of the vertices of these triangles are chosen as points in the ordered sub-list of points. Within the ordered sub-list, these points are ordered according to the value of the array index used in the list stored in the memory unit.

The means 105 make it possible to remove the received point from this sub-list. A triangulation is then carried out by the means 106, on the basis of the points in this sub-list only.

Finally, the updating means 111 also make it possible to update the list of points stored in the memory 110, by removing the received point and optionally by altering certain array index values.

FIG. 2 is an example of an algorithm of a display method when a point is added to an already displayed polygon.

FIGS. 4A to 4D show examples of additions of points to a polygon. For each of these figures the current polygon is shown in solid lines. In FIGS. 4A to 4C a point to be added is also shown, in the form of a star, with an array index value of this point to be added beside it.

An external point is added to the polygon in FIG. 4A, here a simple triangle, i.e. a polygon corresponding to a minimum level of detail. The digit, 2 in the case of FIG. 4A, indicates the array index of the point to be added relative to the list of points of the polygon.

After addition of this point, the polygon in FIG. 4B is obtained.

The polygon in FIG. 4C is the polygon obtained after addition of the internal point shown by a star in FIG. 4B.

The polygon in FIG. 4D is the polygon obtained after addition of the external point shown by a star in FIG. 4C.

To return to FIG. 2, 2D or 3D coordinates of a point Pᵢ₀ to be added are received during a stage 201, with an associated array index value Pᵢ₀, and optionally with a binary variable value EXTᵢ₀.

This binary variable value EXTᵢ₀ indicates whether the point Pᵢ₀ to be added is situated outside a current polygon.

This value can be obtained relatively easily during an optional classification of a set of points corresponding to a complete polygon by levels of detail, in particular if a method such as that described in application

WO2008003687 is implemented. A server storing all of the points by level of detail can thus store for each point this attribute EXTᵢ₀, which may occupy only a single bit.

The ordered list of points P₀, . . . Pᵢ . . . P_{iMAX} is updated during a stage 202, by insertion of the point Pᵢ₀. The indices i that are greater than or equal to i₀ are incremented by 1.

Then, during a stage 203, it is tested whether the received point Pᵢ₀ is outside or inside the polygon defined by the ordered list before the updating during stage 202. For this purpose it may be enough to read the value EXTᵢ₀ and compare it to a value equal to 0 or 1.

Alternatively, it can be determined whether the received point Pₒ is outside or inside the polygon defined by the ordered list before updating from the relative positions of points. For example, the points Pᵢ₀₋₁, Pᵢ₊₁ which precede and follow the received point Pᵢ₀ are identified within the updated list of points. The direction of rotation associated with the sequence Pᵢ₀₋₁, Pᵢ₀, Pᵢ₀₊₁ is determined.

Moreover, the triangle T , having as vertices the points Pᵢ₀₋₁, Pᵢ₀₊₁ is sought in the list of triangles corresponding to the previous triangulation.

For this purpose, use is made of the fact that a single triangle in the list of conforming triangles corresponds to each edge of the polygon. It is possible to provide an additional list of triangles, called the list of triangles of edges, comprising the identifiers of the triangles one edge of which is shared with one edge of the polygon, this list being classified by polygon edge.

On the basis of the points P 10-1, Po+1, the corresponding edge Aⱼ₀ of the current polygon is easily found, and therefore, using the list of triangles of edges, the triangle Tⱼ₀, corresponding to this edge.

This triangle Tⱼ₀, possesses another vertex, denoted P′. The direction of rotation associated with the sequence P_{i0-1, P}ᵢ₀₊₁ is determined.

If this direction of rotation is the same as that associated with the sequence Pᵢ₀₋₁, Pᵢ₀, Pᵢ₀₊, i.e. if the triangles T(Pᵢ₀₋₁, Pᵢ₀, Pᵢ₀₊₁) and Tᵢ₀ have areas with the same sign, then it is considered that the received point Pᵢ₀ is not outside the polygon.

Otherwise, it is considered that the received point Pᵢ₀ is outside the polygon.

In the case of an external point to be added, the triangulation is relatively simple to carry out: the triangle Pᵢ₀₋₁Pᵢ₀Pᵢ₀₊₁ is added to the list of the triangles, during a stage 204.

Such a case in point is illustrated by FIGS. 5A and 5B.

The initial polygon in FIG. 5A is chosen with relatively few points for the sake of clarity, but it will be readily understood that the method can be generalized to cover polygons with a much higher number of points, of the order of tens of thousands for example.

For such a polygon, the following are for example stored in the memory:
an ordered list of points (P₀, P₁, P₂) P₃);
a list of the triangles obtained by the previous triangulation. For each triangle, three storage spaces can for example be provided respectively for three identifiers of points (for the vertices of the triangle) and also three storage spaces respectively for three identifiers of adjacent triangles. The triangles are ordered by convention in the trigonometric direction. In the example in FIG. 5A, this list comprises two triangles:
   T₀: (P₀, P₁, P₂), (0, 0, T₁) since the edges [P₀P₁] and [P₁P₂] belong only to the single triangle T₀, and
   T₁: (P₀) P₂) P₃)) (T₀, 0, 0).
a list of triangles of edges (T₀, T₀, T₁, T₁) corresponding to the list of edges (A₀, A₁, A₂, A₃).

With reference to FIG. 5B, when a point P₄ is added to the polygon P₀P₁ P₂P₃, the edge A₃ is identified as corresponding to the points P₃ and P₀ preceding and following the point P₄ in the updated ordered list of points (P₀, P₁, P₂, P₃) P₄).

Using the list of triangles of edges, the triangle T₁ corresponding to this edge A₃ is found.

The direction of rotation associated with the sequence P₀, P₂, P₃, of the ordered points of the triangle T₁ is the trigonometric direction. The direction of rotation associated with the sequence P₀, P₄, P₃ is the anti-trigonometric direction. The added point P₄ is therefore considered as being outside the polygon P₀P₁P₂P₃.

The triangle P₀P₃P₄ is therefore added to the list of triangles, and to the list of triangles of edges.

To return to FIG. 2, if the added point is not considered as being outside the non-updated polygon, during a stage 224 the triangle Tⱼ₀ comprising the points Pᵢ₀₋₁, Pᵢ₀₊₁ is determined. For this purpose it is possible to use the ordered list of points and the list of triangles of edges, thereby making it possible to avoid examining all of the triangles in the list of triangles in order to find this triangle Tⱼ₀ comprising the points Pᵢ₀₋₁, Pᵢ₀₊₁.

The points of the triangle Tⱼ₀, are selected to form part of an ordered sub-list of points L′, during a stage 213.

A test stage 217 follows, during which it is determined whether the point to be added Pⱼ₀, is inside the triangle Tⱼ₀. Here again, it is possible to proceed by comparisons of signs of signed areas: it is considered that the point Pᵢ₀ is inside the triangle Tⱼ₀ if the direction of rotation associated with the sequences
Pᵢ₀, Pᵢ₀₋₁, P′,
Pᵢ₀₊₁, Pᵢ₀, P′,
Pᵢ₀₊₁, Pᵢ₀₋₁, P′

are the same.

It is recalled that P′ denotes the third vertex (distinct from the vertices Pᵢ₀₊₁, Pᵢ₀₋₁) of the triangle Tⱼ₀.

These test stages 217 can lead us to consider the point Pᵢ₀, as being outside the triangle Tⱼ₀.

FIGS. 6A to 6E illustrate such a case in point: the point to be added P₅ is situated outside the triangle T₁ comprising the edge A₄.

An iterative search then commences for the triangle in the list of triangles that includes the added point.

The triangle Tⱼ₀, here the triangle T₁, is considered as the current triangle during an initialization stage 216. Then during a stage 218 the triangle adjacent to the current triangle, which shares with this current triangle an edge visible from the added point, is selected.

For this the triangles adjacent to the triangle T₁ are considered. If the triangle T₁ is retained in the list of triangles in the form T₁: (P₀, P₂, P₄), (T₀, T₂, 0), it is easy to find the adjacent triangles T₀, T₂.

Then, for each of these adjacent triangles, the edge shared with the current triangle T₁ is also determined, still on the basis of the information stored in the list of triangles. The shared edge [P₀P₂] corresponds to T₀, and the shared edge [P₂P₄] corresponds to T₂.

For each of these shared edges it is determined whether this edge is visible from the added point, i.e. if the triangle formed by this shared edge and the added point has the same area sign as the current triangle, for the shared edge taken in the same direction.

For example, to take up the example in FIG. 6A again:
the anti-trigonometric direction corresponds to the sequence P₅, P₄, P₂,
the anti-trigonometric direction also corresponds to the sequence P₀, P₄, P₂.

The shared edge [P₂P₄] does not constitute an edge visible from the added point P₅.

On the other hand, as illustrated in FIG. 6B:
the trigonometric direction corresponds to the sequence P₂, P₀, P₅,
the anti-trigonometric direction corresponds to the sequence P₂, P₀, P₄.

The edge [P₀P₂] therefore constitutes an edge visible from the added point P₅. The triangle T₀ is therefore chosen during the stage 218.

During a stage 219, the vertices of the triangle selected in stage 218 are added to the sub-list L′, i.e. to take up the example of FIGS. 6A and 6B, the points P₀, P₂, P₁.

During a stage 220 it is tested whether the point to be added belongs to the adjacent triangle, by applying for example a method described with reference to stage 217.

If the point to be added is outside the adjacent triangle, stages 218, 219 and 220 are recommenced, after the adjacent triangle (stage 221) has been chosen as the current triangle. Which triangle the point to be added belongs to is thus sought step by step, while selecting (stage 219) for the sub-list L′ the vertices of the triangles thus examined.

When the triangle to which the point to be added belongs has been determined, on completion of one of the tests 217, 220, a sub-list of points of a polygon which correspond to a portion of the polygon has been obtained. It is possible optionally to provide a stage of re-ordering of the sub-list as a function of the array index of each point, during which doubles would be eliminated.

In this example, the sub-list of points is constituted during the stages 213, 219 of selection of points. However, the invention is by no means limited by the way in which the sub-list of points is constituted. It is possible for example to provide for storage of the identifiers of all of the triangles determined during stages 224, 228, then for the establishing of a list of the edges of these triangles which are outside the polygon, using the triangle list structure stored in the memory. The edges appearing several times are removed, and it is thus possible to obtain an already ordered sub-list of points.

To return to the example of FIGS. 6A and 6B, the sub-list of points comprises the vertices of the triangles T₀ and T₁, and corresponds to a polygon P₀P₁P₂P₄, this polygon P₀P₁P₂P₄ corresponding to a portion of the polygon P₀P₁P₂P₃P₄, as illustrated by FIG. 6C.

During a stage 210, the received point Pᵢ₀ is added to the sub-list L′, taking into account the array index of the point P₀. The sub-list then corresponds to a new polygon, for example, to take up the example of FIGS. 6A to 6C, to the polygon P₁P₂P₄P₅, as illustrated in FIG. 6D.

During a stage 211 a triangulation of this new polygon is carried out, using a conforming triangulation method known from the prior art. As shown in FIG. 6E, the triangles obtained all have the added point as a vertex (FAN or starred triangles).

Then during a stage 212 the list of triangles is updated, and also the list of triangles of edges, as a function of the triangles obtained during stage 211, such that a triangulation of the whole polygon is obtained. To take up the example of FIGS. 6A to 6E, the triangles T₀ and T₁ in the list of triangles corresponding to the previous triangulation (FIG. 6A) are replaced by the triangles T₀, T₁ and T₂ (FIG. 6E).

Also, provision can be made to carry out the updating of the ordered list of points in this stage of the method.

These triangles can be displayed on a screen during a stage 222. FIG. 3 is a flow chart of an example of a method to be executed in the case of removal of a point from the displayed polygon.

During a stage 301 an array index of the point to be removed is received. During a stage 319, all of the triangles in the list of triangles having this point as a vertex are determined.

For this purpose, during a stage 302 the edges [Pᵢ₀₋₁Pᵢ₀] and [Pᵢ₀Pᵢ₀₊₁] comprising this point can be determined.

One [Pᵢ₀₋₁Pᵢ₀] of these edges is chosen and, using the list of triangles of edges, the corresponding triangle Tⱼ₀ is found.

For example, with reference to the example of the triangulated polygon in FIG. 7A, P₄ being the point to be removed, the triangle thus found can be the triangle T₃.

The vertices of this triangle Pⱼ₀⁽¹⁾, Pⱼ₀⁽²⁾, Pⱼ₀⁽³⁾ are retained as points in the sub-list L′ during a stage 303.

If this triangle Tⱼ₀ also comprises the other edge [Pᵢ₀Pᵢ₀₊₁], no other points are added to the sub-list (test 304).

If this triangle Tⱼ₀ does not comprise the other edge [Pᵢ₀Pᵢ₀₊₁], during a stage 305 the triangle T′ⱼ₀ adjacent to this triangle, which comprises the point to be removed, is selected. For this purpose it is possible to use the particular structure of the list of triangles, which retains for each triangle any adjacent triangles.

In the example in FIG. 7A, the triangle T₃ is adjacent to the triangles T₂ and T₄, but only T₄ comprises the point P₄ to be removed. Therefore the triangle T₄ is chosen.

The vertices of this adjacent triangle are added to the sub-list during a stage 306.

The adjacent triangle is then taken as the current triangle (stage 307) and the test 304 consisting of determining whether the adjacent triangle comprises the other edge [Pᵢ₀Pᵢ₀₊₁] is recommenced.

It is thus possible to examine several triangles until the adjacent triangles having Pᵢ₀Pᵢ₀₊₁ as an edge are obtained.

In the example in FIG. 7A, the triangles T₃, T₄, T₅, T₆ are thus examined, in such a way that the points P₃, P₄, P₅, P₆, P₇, P₈ are thus selected.

The invention is by no means limited by the way in which the sub-list of points is constituted. It is possible for example to provide for storage of the identifiers of all of the triangles examined, then to establish a list of the edges of these triangles which are outside the polygon, using the triangle list structure stored in the memory. The edges appearing several times are removed, and it is thus possible to obtain an already ordered sub-list of points. Then the point to be removed is removed from this sub-list (stage 308).

During a stage 309 a triangulation of the polygon corresponding to the remaining points is carried out, for example P₃P₅P₆P₇P₈ in the case in FIG. 7A.

Then the different lists are updated during a stage 310. Finally, the triangles are displayed during a stage 311.

FIG. 7B shows the polygon in FIG. 7A, updated by the removal of the point P₄, and triangulated.

1. Triangulation device for a digital display on a screen of a terminal, said device comprising
a memory unit for storing an ordered list of points ({Pᵢ}) corresponding to a polygon, as well as a list of conforming triangles ({Tᵢ}) obtained by conforming triangulation from said ordered list of points,
receiving means of an identifier of a point to be added to/removed from the ordered list of points,
first processing means for determining, as a function of the received identifier and of the list of conforming triangles, an ordered sub-list of points in the ordered list, of said sub-list corresponding to a portion of the polygon,
second processing means for adding/removing the point to be added to/removed from said sub-list,
triangulation means connected to an output from the second processing means, for carrying out a conforming triangulation of the polygon corresponding to said sub-list, and
updating means arranged for updating, as a function of the conforming triangles obtained by the triangulation means, the list of conforming triangles stored in the memory unit, for the display of the triangles in said updated list on the screen.

2. Device according to claim 1, also comprising
means of updating the ordered list of points stored in the memory unit, said means being arranged, when the identifier of the point received by the receiving means comprises coordinates of said point and an indication of the order of said point, to add said received point to said ordered list, in an array given by the received order indication,
and in which
the first processing means are arranged in order to
determine whether said received point is situated outside the polygon corresponding to the list of triangles stored in the memory unit,
if appropriate, choose the two points in the ordered list adjacent to the received point as points on the sub-list,
otherwise, to determine a set of at least one triangle in the list of triangles stored in the memory unit, said set being constituted by all the triangles in said list at least partly covered by the triangle formed by the received point and the two points in the ordered list adjacent to said received point, and to choose as points on the ordered sub-list the points corresponding to said set.

3. Device according to claim 1, in which
the first processing means are arranged in order, when the identifier of the point received by the receiving means comprises an identifier of a point in the ordered list of points stored in the memory unit, to choose as points on the ordered sub-list of points all of the points of the triangles in the list of triangles of the previous triangulation which have the received point as a vertex,
the device also comprising
updating means arranged in order to remove said received point from the ordered list of points stored in the memory unit.

4. Conforming triangulation method, for a digital display on a terminal screen, comprising
a/receiving an identifier of a point to be added to/removed from an ordered list of points corresponding to a polygon, said polygon having been the subject of a previous conforming triangulation,
b/ determining, as a function of the identifier received and a list of conforming triangles obtained by the previous triangulation, an ordered sub-list of points in the ordered list, said sub-list corresponding to a portion of the polygon,
c/adding/removing the point to be added to/removed from said sub-list,
d/carrying out a conforming triangulation of the polygon corresponding to the sub-list obtained in stage c/, and
e/updating the list of conforming triangles obtained by the previous triangulation, as a function of the results of the triangulation of stage d/, for a display on the screen.

5. Method according to claim 4, in which the identifier of the received point comprises coordinates of said point and an indication of the order of said point, the method comprising
adding said received point to the ordered list of points corresponding to the previously triangulated polygon, in an array given by the received order indication,
in stage b/, determining whether said received point is situated outside the previously triangulated polygon,
if appropriate, in stage e/, adding to the list of triangles corresponding to the previous triangulation, the triangle formed by the received point (Pᵢ₀) and the two points (Pᵢ₀₋₁, Pᵢ₀₊₁) in the ordered list adjacent to said point,
otherwise determining during stage b/ a set of at least one triangle in the list of triangles corresponding to the previous triangulation, said set being constituted by all the triangles in said list at least partly covered by the triangle formed by the received point and the two points in the ordered list adjacent to said received point, and choosing as points in the ordered sub-list, the points corresponding to said set.

6. Method according to claim 5, in which it is determined whether the received point is situated outside the previously triangulated polygon on the basis of a received indication (EXTᵢ₀).

7. Method according to claim 5, in which, in order to determine the set of at least one triangle in the list of triangles
if the received point (Pᵢ₀) is in the triangle (Tⱼ₀) in the list of triangles comprising the two points (Pᵢ₀₋₁, Pᵢ₀₊₁) in the ordered list adjacent to said received point, the vertices of said triangle are chosen as points in the sub-list of points,
otherwise, the vertices of the triangle in the list of triangles comprising said two points in the ordered list are selected as points in the sub-list, then for a current triangle (Tₖ) being initially said triangle in the list of triangles comprising said two points in the ordered list, the following stages are carried out:
b1/choosing a triangle (Tₖ₊₁) adjacent to the current triangle sharing with said current triangle an edge visible from the received point,
b2/selecting the vertices of the adjacent triangle as points in the sub-list, and
b3/if the received point is outside the adjacent triangle, repeating stages b1/, b2/and b3/considering the adjacent triangle as the current triangle, until the adjacent triangle to which the received point belongs is found.

8. Method according to claim 4, in which the identifier of the received point comprises an identifier (i₀) of a point in the ordered list of points corresponding to the previously triangulated polygon, comprising in stage b/, choosing as points in the ordered sub-list of points all the points of the triangles in the list of triangles of the previous triangulation which have the received point as a vertex, and
removing said received point from the ordered list of points.

9. Method according to claim 4, in which provision is made to retain, for each edge of the previously triangulated polygon, an identifier of the triangle comprising said edge.

10. Computer program comprising instructions for implementing the stages of a method according to claim 4 during an execution of the program by processing means.
